(19) United States
(12) Patent Application Publication
(10) Pub. No.: US 2025/0310266 A1
(43) Pub. Date: Oct. 2, 2025

(54) COMPUTER-READABLE RECORDING MEDIUM, QUALITY EVALUATION METHOD, AND QUALITY EVALUATION DEVICE

(71) Applicant: Fujitsu Limited, Kawasaki-shi (JP)

(72) Inventors: Junki OURA, Kawasaki (JP); Masatoshi OGAWA, Zama (JP); Kaoru YOKOO, Yokosuka (JP)

(73) Assignee: Fujitsu Limited, Kawasaki-shi (JP)

(21) Appl. No.: 19/232,613

(22) Filed: Jun. 9, 2025

Related U.S. Application Data
(63) Continuation of application No. PCT/JP2023/045057, filed on Dec. 15, 2023.

(30) Foreign Application Priority Data
Feb. 10, 2023 (JP) 2023-019300

(51) Int. Cl. H04L 47/2441; H04L 43/026

(52) U.S. Cl. CPC H04L 47/2441; H04L 43/026

(57) ABSTRACT

A non-transitory computer-readable recording medium stores therein a quality evaluation program that causes a computer to execute a process including acquiring a plurality of packets from a network used by a plurality of terminals for communication, first classifying the plurality of packets into a plurality of flows based on a relationship between a source terminal and a destination terminal set in the plurality of packets, extracting characteristics of the plurality of flows obtained at the first classifying, second classifying the plurality of flows into a plurality of groups based on the characteristics of the plurality of flows, selecting a representative flow based on communication states of a plurality of flows classified into the same group, and evaluating quality of each representative flow selected from each group.

### CROSS-REFERENCE TO RELATED APPLICATION

This application is a continuation application of International Application No. PCT/JP2023/045057, filed on Dec. 15, 2023 which claims the benefit of priority of the prior Japanese Patent Application No. 2023-019300, filed on Feb. 10, 2023, the entire contents of which are incorporated herein by reference.

### FIELD

The embodiment discussed herein is related to a computer-readable recording medium and the like.

### BACKGROUND

With appearance of various types of application software (hereinafter, applications), demands on a network are changing day by day. In order to effectively use limited network resources, it is needed to appropriately allocate the network resources to a plurality of applications according to importance and characteristics.

Up until now, for example, an operator has monitored the network, evaluated service quality of each terminal, and allocated the network resources.

FIG. 16 is a diagram for describing an example of the allocation of the network resources. Here, the description will be given using a terminal X1, a terminal X2, and a terminal X3. Before control, an allocated bandwidth is “3000 kbps” for a requested bandwidth “2000 kbps” of the terminal X1. The allocated bandwidth is “3000 kbps” for a requested bandwidth “4000 kbps” of the terminal X2. The allocated bandwidth is “3000 kbps” for a requested bandwidth “2500 kbps” of the terminal X3.

Before the control, the allocated bandwidths for the terminal X1 and the terminal X3 are equal to or more than the requested bandwidths, but the allocated bandwidth for the terminal X2 is less than the requested bandwidth. Therefore, the operator determines that service quality for the terminal X2 is poor, and controls the allocated bandwidth. Since there is an upper limit to a total value of the allocated bandwidths, the operator reduces the allocated bandwidths of the terminal X1 and the terminal X3, which exceed the requested bandwidths, and increases an allocated area of the terminal X2, which falls below the requested bandwidth.

After the control, the allocated bandwidth is “2200 kbps” for the requested bandwidth “2000 kbps” of the terminal X1. The allocated bandwidth is “4100 kbps” for the requested bandwidth “4000 kbps” of the terminal X2. The allocated bandwidth is “2700 kbps” for the requested bandwidth “2500 kbps” of the terminal X3.

As described above, by controlling the allocated bandwidths, the respective allocated bandwidths for the terminal X1, the terminal X2, and the terminal X3 can be set to be equal to or more than the respective requested bandwidths.
Patent Document 1: International Publication Pamphlet No. WO 2016/203749 A
Patent Document 2: Japanese Laid-open Patent Publication No. 2017-139580
Patent Document 3: U.S. Patent Application Publication No. 2014/0334309
Patent Document 4: U.S. Patent Application Publication No. 2022/0239720

However, it is becoming impractical to manually evaluate service quality from a viewpoint of complexity of the network. Furthermore, it is fairer from a viewpoint of user perceived quality to evaluate service quality provided by each application used by a user and to control the network based on a result of such evaluation than to control the network based on quality of the network.

Therefore, it is needed to evaluate the service quality provided by the application in a communication status of the network.

### SUMMARY

According to an aspect of an embodiment, a non-transitory computer-readable recording medium stores therein a quality evaluation program that causes a computer to execute a process including acquiring a plurality of packets from a network used by a plurality of terminals for communication, first classifying the plurality of packets into a plurality of flows based on a relationship between a source terminal and a destination terminal set in the plurality of packets, extracting characteristics of the plurality of flows obtained at the first classifying, second classifying the plurality of flows into a plurality of groups based on the characteristics of the plurality of flows, selecting a representative flow based on communication states of a plurality of flows classified into the same group, and evaluating quality of each representative flow selected from each group.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing a flow of network control according to a reference technology;

FIG. 2 is a diagram for describing a problem of service quality evaluation and the network control;

FIG. 3 is a diagram for describing a solution;

FIG. 4 is a diagram illustrating an example of a system according to the present embodiment;

FIG. 5 is a diagram for describing processing of a quality evaluation device according to the present embodiment;

FIG. 6 is a functional block diagram illustrating a configuration of the quality evaluation device according to the present embodiment;

FIG. 7 is a diagram for describing pre-processing of a grouping unit;

FIG. 8 is a diagram for describing classification processing of the grouping unit;

FIG. 9 is a diagram for describing processing of an evaluation unit;

FIG. 10 is a diagram (1) for describing processing of a network control unit;

FIG. 11 is a diagram (2) for describing the processing of the network control unit;

FIG. 12 is a flowchart illustrating a processing procedure of the quality evaluation device according to the present embodiment;

FIG. 13 is a flowchart illustrating processing of updating a group table;

FIG. 14 is a flowchart illustrating processing of evaluating service quality;

FIG. 15 is a diagram illustrating an example of a hardware configuration of a computer that implements functions similar to those of the quality evaluation device of the embodiment; and

FIG. 16 is a diagram for describing an example of allocation of network resources.

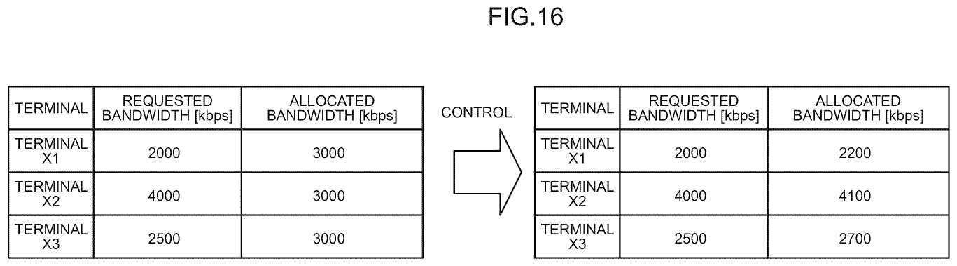

### DESCRIPTION OF EMBODIMENT

Preferred embodiments will be explained with reference to accompanying drawings. Note that this invention is not limited by this embodiment.

Before describing a quality evaluation device according to the present embodiment, a reference technology for evaluating service quality provided by an application and controlling a network will be described. A device that executes processing of the reference technology is referred to as a “reference device”. The reference technology is a technology at a previous stage of the quality evaluation device of the present invention, and does not correspond to a conventional technology.

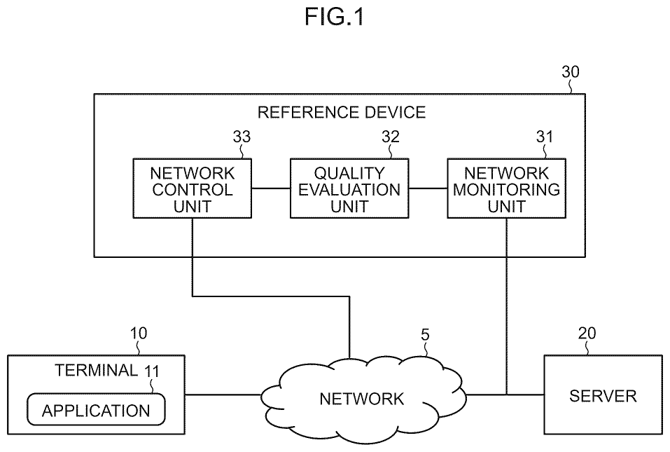

FIG. 1 is a diagram for describing a flow of the network control according to the reference technology. In the example illustrated in FIG. 1, a terminal 10 is connected to a server 20 via a network 5. The terminal 10 activates an application 11. The terminal is a personal computer (PC), a notebook PC, a tablet terminal, a smartphone, or the like. The application 11 is a video call application, a video streaming application, a voice call application, an e-mail application, or the like.

The application 11 executes packet communication with the server 20 and provides a service for a user of the terminal 10. Although not illustrated, it is assumed that terminals other than the terminal 10 and servers other than the server 20 are also connected to the network 5, and each terminal activates an application, executes packet communication with each server, and receives service provision from each server.

A reference device 30 includes a network monitoring unit 31, a quality evaluation unit 32, and a network control unit 33. The reference device 30 is connected to the network 5.

The network monitoring unit 31 captures a packet flowing through the network 5, and outputs the captured packet to the quality evaluation unit 32. The network monitoring unit 31 intermittently executes the above processing at a constant cycle.

The quality evaluation unit 32 evaluates service quality of each application used by each terminal based on the captured packet, and outputs a result of the evaluation to the network control unit 33.

The network control unit 33 acquires the result of evaluation regarding the service quality, and controls the network 5 so that an average value and a minimum value of the service quality are maintained at equal to or more than a certain value. The control executed on the network 5 by the network control unit 33 is bandwidth control, scheduler control, and the like.

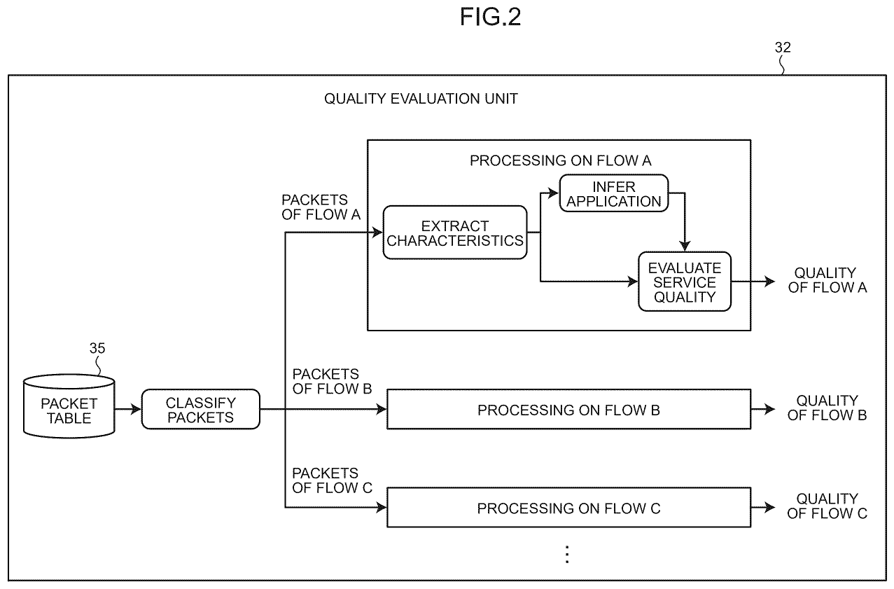

Here, a problem of the service quality evaluation and the network control by the reference technology will be described. FIG. 2 is a diagram for describing the problem of the service quality evaluation and the network control.

In FIG. 2, a packet table 35 stores a plurality of packets captured by the network monitoring unit 31. For example, the quality evaluation unit 32 of the reference device 30 analyzes the packets stored in the packet table 35, and executes packet classification. The quality evaluation unit 32 classifies the packets into a plurality of flows based on source addresses, destination addresses, source port numbers, and destination port numbers of the packets. The quality evaluation unit 32 classifies, into the same flow, a packet group in which a set of the source address and the destination address is the same and a set of the source port number and the destination port number is the same.

The quality evaluation unit 32 evaluates quality of the flow for each flow. Here, a case will be described where quality of a flow A is evaluated based on packets classified into the flow A. The quality evaluation unit 32 extracts characteristics from the packets of the flow A.

The quality evaluation unit 32 infers an application corresponding to the flow A based on the extracted characteristics of the packets. The quality evaluation unit 32 evaluates the quality (service quality) of the flow A based on the inferred application and the extracted characteristics of the packets.

The quality evaluation unit 32 executes the above processing on packets of a flow B, packets of a flow C, and packets of another flow, and evaluates each of quality of the flow B, quality of the flow C, and quality of the another flow.

The quality evaluation unit 32 repeatedly executes parallel calculation for evaluating the quality of each flow in a cycle of about 1 second. To execute the above processing for each flow on an object network and evaluate the service quality, enormous calculation resources are needed. For example, the following two solutions are conceivable as solutions to such a problem.

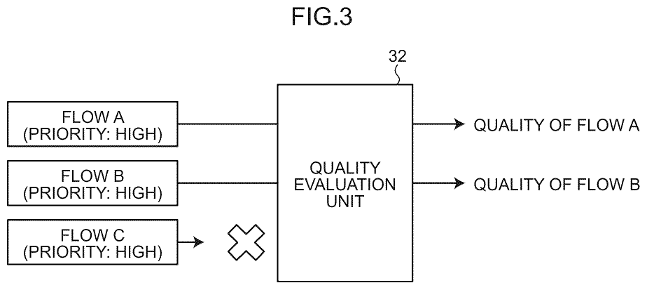

The first solution is a solution to guarantee the quality only for a flow with high priority among the plurality of flows. FIG. 3 is a diagram for describing the solution. In the example illustrated in FIG. 3, it is assumed that priority of the flows A and B is high and priority of the flow C is low among the flows A to C. In this case, the quality evaluation unit 32 evaluates the quality of the flows A and B and does not evaluate the quality of the flow C. With this configuration, an object to be evaluated can be limited to the flows with high priority, but it becomes not possible to reduce a calculation amount in a case where the number of flows with high priority increases.

The second solution is a solution to select a representative flow from the flows belonging to the same radio access network (RAN) or the same slice, and evaluate quality of the selected representative flow. However, in the second solution, a quality evaluation value may be different depending on a position of a terminal, network setting, and an application.

For example, even in a case where a flow of a terminal X-A and a flow of a terminal X-B belong to the same slice and evaluation of the flow corresponding to the terminal X-A is high, there may be a case where evaluation of the flow for the terminal X-B is not high. Therefore, when the flow corresponding to the terminal X-A is selected as a representative and the network control is performed based on a result of evaluation of such a flow, quality of a service for the terminal X-B may remain low.

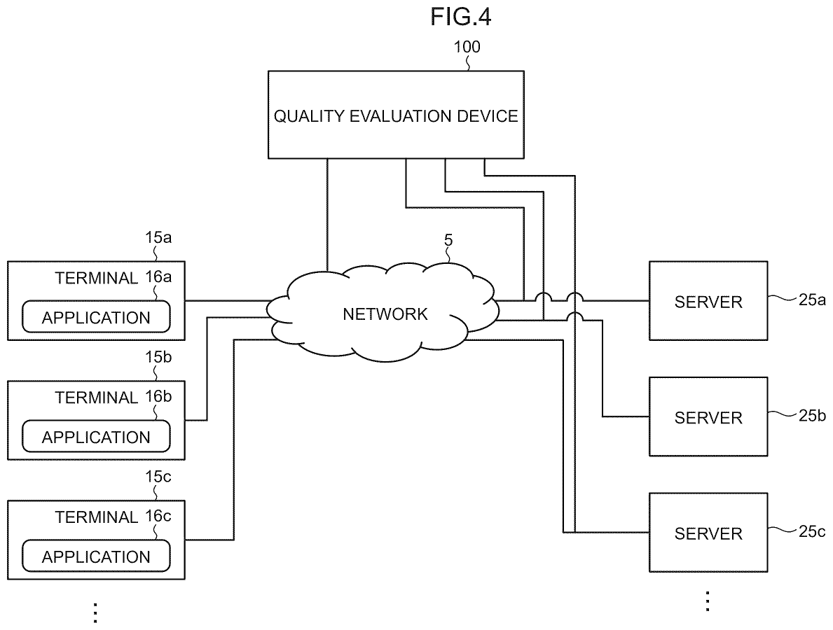

Next, description of the present embodiment will be made. FIG. 4 is a diagram illustrating an example of a system according to the present embodiment. As illustrated in FIG. 4, the system according to the present embodiment includes terminals 15a, 15b, and 15c, servers 25a, 25b, and 25c, and a quality evaluation device 100.

The terminals 15a to 15c, the servers 25a to 25c, and the quality evaluation device 100 are connected to a network 5. Although not illustrated, the system according to the present embodiment may further include a terminal other than the terminals 15a to 15c and a server other than the servers 25a to 25c.

The terminals 15a to 15c activate applications 16a to 16c, respectively. The terminals 15a to 15c are PCs, notebook PCs, tablet terminals, smartphones, or the like. In the following description, the terminals 15a to 15c are collectively referred to as “terminals 15”.

The applications 16a to 16c are video call applications, video streaming applications, voice call applications, e-mail applications, or the like. The applications 16a to 16c execute packet communication with the servers 25a, 25b, and 25c via the network 5. In the following description, the applications 16a to 16c are collectively referred to as “applications 16”.

The servers 25a to 25c execute packet communication with the applications 16 of the terminals 15, and provide services. In the following description, the servers 25a to 25c are collectively referred to as “servers 25”.

The quality evaluation device 100 classifies a plurality of packets passing through the network 5 for each flow, extracts characteristics, and classifies flows having close characteristics into the same group. The quality evaluation device 100 selects a flow having a relatively low communication state from each group as a representative flow, and evaluates service quality for the representative flow of each group. The quality evaluation device 100 sets a result of the evaluation of the service quality of the representative flow as a result of evaluation of service quality of each flow belonging to the group to which the representative flow belongs, and controls the network 5 so that the service quality is maintained at certain quality or higher quality. The control executed on the network 5 by the quality evaluation device 100 is bandwidth control, scheduler control, and the like.

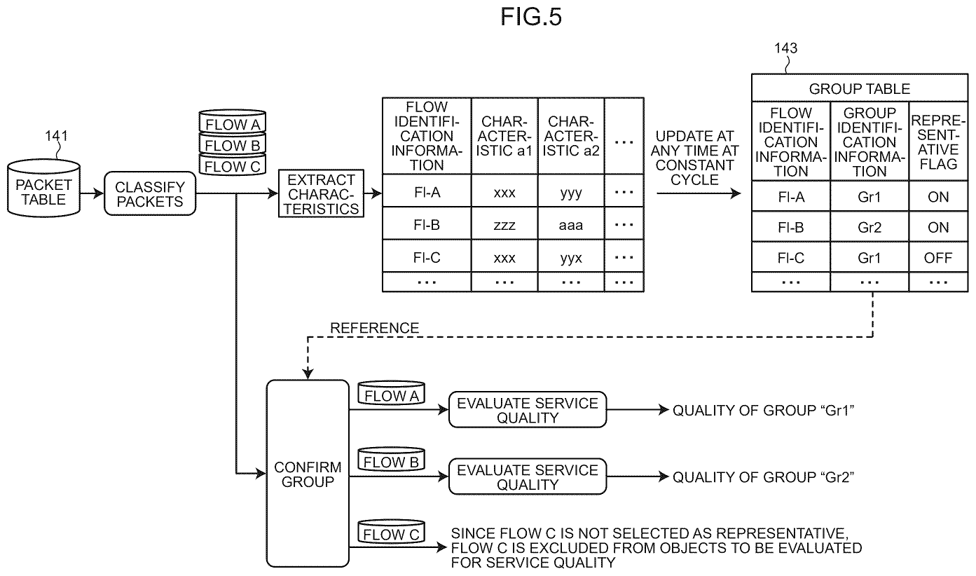

FIG. 5 is a diagram for describing processing of the quality evaluation device according to the present embodiment. In FIG. 5, a packet table 141 stores a plurality of packets captured from the network 5. The quality evaluation device 100 analyzes the packets stored in the packet table 141, and executes packet classification. The quality evaluation device 100 classifies the packets into a plurality of flows based on source addresses, destination addresses, and port numbers of the packets. The quality evaluation device 100 classifies, into the same flow, a packet group in which a set of the source address and the destination address is the same and a set of a source port number and a destination port number is the same. The example illustrated in FIG. 5 illustrates an example in which the packet group is classified into a flow A, a flow B, and a flow C.

The quality evaluation device 100 extracts characteristics from the flows A and B, and generates a characteristic table 142 based on a result of the extraction of the characteristics. The characteristic table 142 associates flow identification information with a plurality of characteristics a1, a2, and the like.

The flow identification information is information for identifying a flow. For example, the flow identification information regarding the flow A is defined as “F1-A”, the flow identification information regarding the flow B is defined as “F1-B”, and the flow identification information regarding the flow C is defined as “F1-C”.

The characteristics (the characteristic a1 and the characteristic a2) are characteristics of a traffic pattern, and include an average number of times of passage per hour, a total capacity, a burst frequency, a length, a request frequency, and the like.

The quality evaluation device 100 classifies flows having close characteristics into the same group based on the characteristic table 142. The quality evaluation device 100 selects, as a representative flow, a flow having a communication state relatively lower than communication states of other flows based on a communication state of each flow included in the same group.

The quality evaluation device 100 generates a group table 143 based on a result of the classification of the group and a result of the selection of the representative flow. The group table 143 associates the flow identification information, group identification information, and a representative flag. The flow identification information is information for identifying a flow.

The group identification information is information for identifying a group to which a flow belongs. In the example illustrated in FIG. 5, it is indicated that the flow A with the flow identification information “F1-A” and the flow C with the flow identification information “F1-C” belong to a group with group identification information “Gr1”. It is indicated that the flow B with the flow identification information “F1-B” belongs to a group with group identification information “Gr2”.

The representative flag is information indicating whether or not the corresponding flow is a representative flow. In a case where the corresponding flow is the representative flow, the representative flag is “ON”. On the other hand, in a case where the corresponding flow is not the representative flow, the representative flag is “OFF”.

For example, in the example illustrated in FIG. 5, it is indicated that the representative flow is the flow A with the flow identification information “F1-A” among a plurality of flows belonging to the group with the group identification information “Gr1”. It is indicated that the representative flow is the flow B with the flow identification information “F1-B” among a plurality of flows belonging to the group with the group identification information “Gr2”. Note that it is indicated that the flow C with the flow identification information “F1-C” is not the representative flow.

In the following description, a group with group identification information “GrX” is appropriately referred to as a group GrX. For example, the group with the group identification information “Gr1” is referred to as the group Gr1.

The quality evaluation device 100 executes processing of specifying the representative flow among the plurality of flows based on the group table 143, and evaluating service quality for the representative flow. For example, the quality evaluation device 100 sets a result of evaluation of service quality for the flow A to be the representative flow as a result of evaluation of service quality of each flow belonging to the group Gr1. The quality evaluation device 100 sets a result of evaluation of service quality for the flow B to be the representative flow as a result of evaluation of service quality of each flow belonging to a group Gr2.

The quality evaluation device 100 excludes the service quality for the flows other than the representative flow from objects to be evaluated. For example, since the flow C does not correspond to the representative flow, the quality evaluation device 100 excludes the flow C from the objects to be evaluated for the service quality. With this configuration, a calculation amount for evaluating service quality for the flow C can be reduced.

As described above, according to the quality evaluation device 100 according to the present embodiment, it is possible to evaluate service quality provided by an application in a communication status of a network.

For example, the quality evaluation device 100 classifies a plurality of packets passing through the network 5 for each flow, extracts characteristics, and classifies flows having close characteristics into the same group. The quality evaluation device 100 selects a flow having a relatively low communication state from each group as a representative flow, and evaluates service quality for the representative flow of each group. With this configuration, it is possible to optimize the flows to be evaluated for the service quality and reduce a calculation amount related to the evaluation of the service quality.

Since the quality evaluation device 100 classifies the flows having the close characteristics into the same group and selects the representative flow from the group, it is possible to suppress an increase in the calculation amount due to an increase in the number of flows.

Since the quality evaluation device 100 selects, as the representative flow, the flow having the relatively low communication state from each group, it is also possible to improve the service quality of each flow in the group by controlling the network 5 based on the service quality of the representative flow.

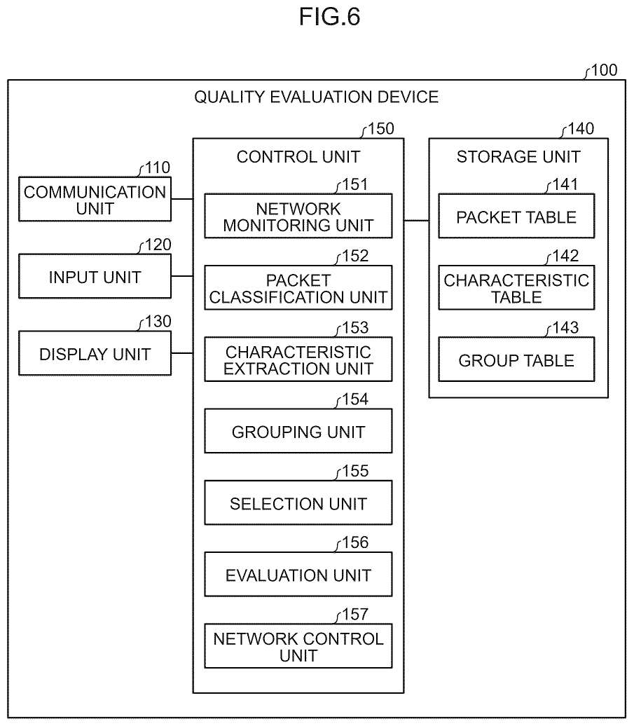

Next, a configuration example of the quality evaluation device 100 that executes the processing illustrated in FIG. 5 will be described. FIG. 6 is a functional block diagram illustrating a configuration of the quality evaluation device according to the present embodiment. As illustrated in FIG. 6, the quality evaluation device 100 includes a communication unit 110, an input unit 120, a display unit 130, a storage unit 140, and a control unit 150.

The communication unit 110 executes data communication (packet communication) with each communication device on the network 5. The communication unit 110 is a network interface card (NIC) or the like. A network monitoring unit 151 of the control unit 150 captures packets on the network 5 using the communication unit 110.

The input unit 120 is an input device that inputs various types of information into the control unit 150 of the quality evaluation device 100. For example, the input unit 120 corresponds to a keyboard, a mouse, a touch panel, or the like.

The display unit 130 is a display device that displays information output from the control unit 150.

The storage unit 140 includes the packet table 141, the characteristic table 142, and the group table 143. The storage unit 140 is a storage device such as a memory.

The packet table 141 stores packets captured by the network monitoring unit 151. Other descriptions regarding the packet table 141 are similar to those of the packet table 141 described with reference to FIG. 5.

The characteristic table 142 stores information regarding characteristic of flows extracted by a characteristic extraction unit 153. As described with reference to FIG. 5, the characteristic table 142 associates the flow identification information with each characteristic. Other descriptions regarding the characteristic table 142 are similar to those of the characteristic table 142 described with reference to FIG. 5.

The group table 143 stores information regarding a result of classification of each flow by a grouping unit 154 and a result of selection of a representative flow by a selection unit 155. As described with reference to FIG. 5, the group table 143 associates the flow identification information, the group identification information, and the representative flag. Other descriptions regarding the group table 143 are similar to those of the group table 143 described with reference to FIG. 5.

The control unit 150 includes the network monitoring unit 151, a packet classification unit 152, the characteristic extraction unit 153, the grouping unit 154, the selection unit 155, an evaluation unit 156, and a network control unit 157. The control unit 150 is a central processing unit (CPU), a graphics processing unit (GPU), or the like.

The network monitoring unit 151 captures packets flowing through the network 5, and stores the captured packets in the packet table 141. The network monitoring unit 151 intermittently executes the above processing at a constant cycle.

The packet classification unit 152 analyzes the packets stored in the packet table 141, and executes packet classification. The packet classification unit 152 classifies the packets into a plurality of flows based on source addresses, destination addresses, source port numbers, and destination port numbers of the packets. For example, the packet classification unit 152 classifies, into the same flow, a packet group in which a set of the source address and the destination address is the same and a set of the source port number and the destination port number is the same.

The packet classification unit 152 sets the flow identification information to each flow to which the packet group belongs. The packet classification unit 152 outputs a result of the classification of the flows to the characteristic extraction unit 153.

The characteristic extraction unit 153 analyzes the packet group of the flow unit, and extracts characteristics of the flow unit. The characteristic extraction unit 153 extracts, as the characteristics, a traffic pattern such as an average number of times of passage per hour, a total capacity, a burst frequency, a length, and a request frequency. The characteristic extraction unit 153 may further extract the number of times of retransmission of packets and a round trip time (RTT) as the characteristics. The characteristic extraction unit 153 stores a result of the extraction of the characteristics in the characteristic table 142.

For example, the characteristic extraction unit 153 stores the flow identification information and each characteristic in association with each other in the characteristic table 142.

The characteristic extraction unit 153 intermittently executes the above processing of calculating the characteristics at a predetermined cycle. It is assumed that the cycle (predetermined cycle) of the processing of calculating the characteristics is the same cycle as a cycle in which the evaluation unit 156 evaluates service quality.

The grouping unit 154 groups each flow based on the characteristics of each flow stored in the characteristic table 142. The grouping unit 154 classifies flows having close characteristics into the same group. The grouping unit 154 stores a relationship between the flow identification information and the group identification information in the group table 143.

Here, an example of more specific processing of the grouping unit 154 will be described. For example, the grouping unit 154 executes pre-processing and classification processing.

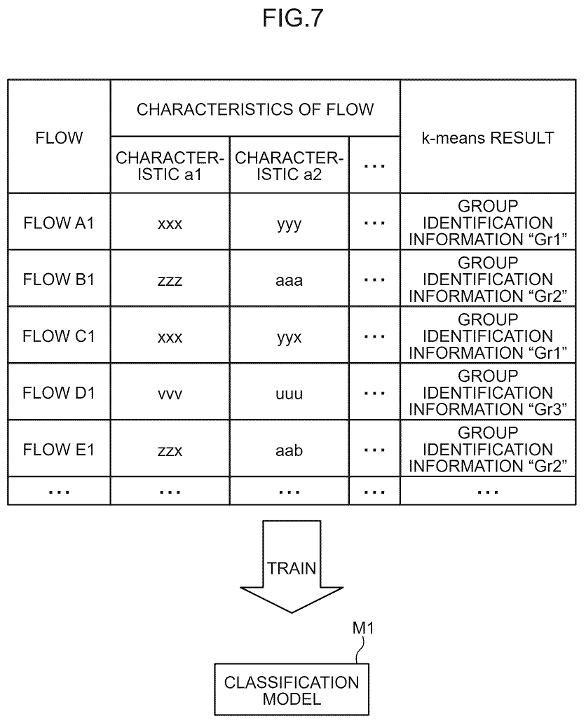

The pre-processing of the grouping unit 154 will be described. FIG. 7 is a diagram for describing the pre-processing of the grouping unit. The grouping unit 154 acquires the characteristics of each flow in advance and performs classification by a k-means method on the characteristics of each flow, thereby specifying a relationship between the characteristics of the flow and a result of the classification (group identification information) of the k-means method. When the number of classes obtained by the classification by the k-means method increases, the number of times of evaluation of service quality operated in parallel also increases. Therefore, the number of classes is set in advance using the number that can be operated by the quality evaluation device 100 in parallel as a guide.

In the example illustrated in FIG. 7, a flow A1 is classified into the group Gr1 by performing the classification by the k-means method. A flow B1 is classified into the group Gr2. A flow C1 is classified into the group Gr1. A flow D1 is classified into a group Gr3. A flow E1 is classified into the group Gr2.

The grouping unit 154 trains a classification model M1 based on backpropagation with the characteristics of the flow as “input data” and the result of the classification (group identification information) by the k-means method as “correct answer label”. For example, the grouping unit 154 inputs the input data into the classification model M1, and updates parameters of the classification model M1 so that an output from the classification model M1 approaches the correct answer label. The classification model M1 is a neural network (NN).

Here, the classification model M1 has been described as the NN, but the classification model M1 may be Random Forest, XGBoost, or the like.

The grouping unit 154 may specify, by classifying the information set in the characteristic table 142 by the k-means method, the relationship between the characteristics of the flow and a result of the classification of the k-means method again, and retrain the classification model M1 using the specified information as teacher data.

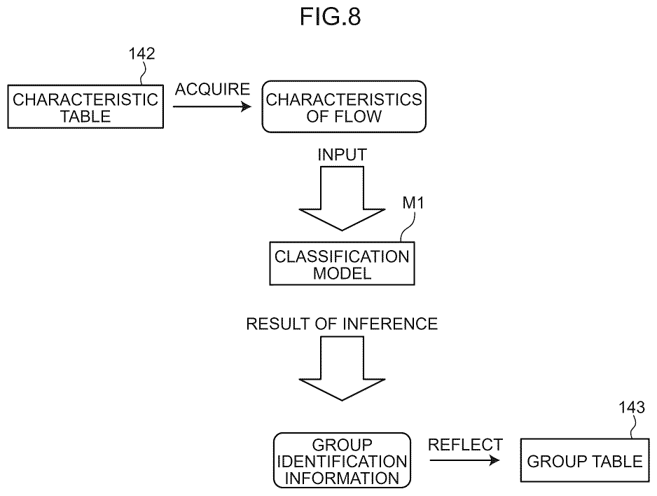

The classification processing of the grouping unit 154 will be described. FIG. 8 is a diagram for describing the classification processing of the grouping unit. The grouping unit 154 acquires the characteristics of the flows stored in the characteristic table 142. The grouping unit 154 infers the group identification information by inputting the acquired characteristics of the flows to the trained classification model M1. The grouping unit 154 performs reflection in the group table 143 based on a result of the inference.

For example, it is assumed that the grouping unit 154 inputs the characteristic of the flow A into the classification model M1, and the group identification information “Gr1” is output from the classification model M1. In this case, the grouping unit 154 stores, in the group table 143, information in which the flow identification information “F1-A” of the flow A is associated with the group identification information “Gr1”.

The grouping unit 154 repeatedly executes the above processing for the characteristics of each flow stored in the characteristic table 142 to specify the relationship between the flow identification information and the group identification information and update the group table 143.

It is assumed that a cycle in which the grouping unit 154 performs the classification processing is set to be a slower cycle than the cycle in which the evaluation unit 156 evaluates service quality.

The description returns to FIG. 6. The selection unit 155 selects a representative flow based on the characteristics of the plurality of flows classified into the same group. Hereinafter, an example of processing of the selection unit 155 will be described.

The selection unit 155 refers to the group table 143 and executes the following processing to select the representative flow from each group.

The selection unit 155 specifies the flow identification information corresponding to the same group identification information, and acquires a part of characteristics corresponding to the specified flow identification information from the characteristic table 142. For example, it is assumed that a part of the characteristics acquired by the selection unit 155 includes “the number of times of retransmission” and “RTT”. The selection unit 155 selects, as the representative flow, a flow having a relatively poor communication status in the same group based on at least one of the number of times of retransmission and the RTT corresponding to each piece of the flow identification information.

For example, the selection unit 155 creates a distribution indicating a relationship between the number of flows and the number of times of retransmission, and selects a flow corresponding to the lower no of the distribution as the representative flow. Alternatively, the selection unit 155 may sort each flow in descending order of the number of times of retransmission (or in descending order of the RTT), and select an m-th flow from a flow having the largest number of times of retransmission as the representative flow. Preset numerical values are represented by n and m.

The selection unit 155 repeatedly executes the processing of selecting the representative flow (flow identification information corresponding to the representative flow) for each piece of the group identification information, and updates the group table 143. In the group table 143, the selection unit 155 sets a representative flag corresponding to the flow identification information regarding the representative flow to “ON”, and sets representative flags corresponding to flow identification information regarding flows other than the representative flow to “OFF”.

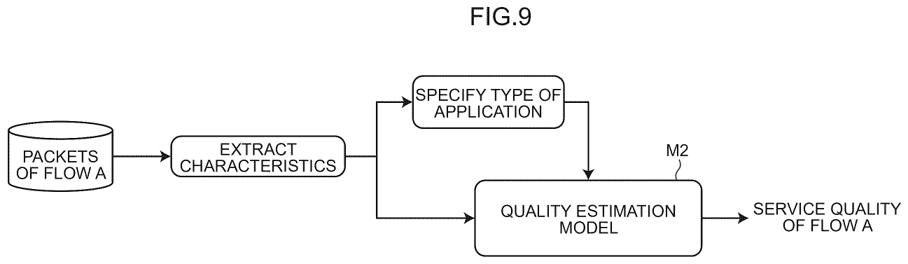

The evaluation unit 156 evaluates service quality of the representative flow based on characteristics of the representative flow. FIG. 9 is a diagram for describing processing of the evaluation unit. In FIG. 9, the description will be made assuming that the representative flow is the “flow A”.

The evaluation unit 156 analyzes packets of the flow A, and extracts characteristics of the flow A. The evaluation unit 156 may use the characteristics of the flow A stored in the characteristic table 142.

The evaluation unit 156 specifies a type of an application corresponding to the flow A based on the characteristics of the flow A. For example, the evaluation unit 156 specifies the type of the application corresponding to the flow A based on a determination table or the like in which information regarding a control header or information regarding a data amount of the packet is associated with the type of the application. The processing in which the evaluation unit 156 specifies the type of the application from the characteristics of the flow is not limited to the above processing, and another known technology may be used.

The evaluation unit 156 estimates the service quality of the flow using a quality estimation model M2 trained in advance. The quality estimation model M2 is a machine learning model in which the characteristics of the flow and the type of the application are used as input data and the service quality is used as an output. The quality estimation model M2 is an NN or the like.

The evaluation unit 156 evaluates the service quality of each representative flow by repeatedly executing the above processing for each representative flow. The evaluation unit 156 outputs a result of the evaluation of the service quality of each representative flow to the network control unit 157. The flow identification information of each representative flow and the result of the evaluation of the service quality are associated with information regarding the result of the evaluation. The evaluation unit 156 repeatedly executes the processing of evaluating the service quality at the predetermined cycle, and repeatedly outputs the result of the evaluation to the network control unit 157.

Here, the evaluation unit 156 uses user experience (UX), a system usability scale (SUS), and quality of experience (QoE) to acquire in advance a relationship among the type of application, the characteristics of the flow, and a satisfaction level of a user for the service quality. The evaluation unit 156 generates the relationship among the type of the application, the characteristics of the flow, and the satisfaction level of the service quality as teacher data, and trains the quality estimation model M2 based on the backpropagation or the like. The evaluation unit 156 may acquire the quality evaluation model M2 trained in advance from an external device, and use the quality evaluation model M2.

The description returns to FIG. 6. The network control unit 157 controls, for each group, a bandwidth to be allocated to each terminal based on the result of the evaluation of the evaluation unit 156 so that the service quality of each representative flow becomes uniform. It is assumed that the network control unit 157 performs bandwidth control by communicating with a communication device of the network 5.

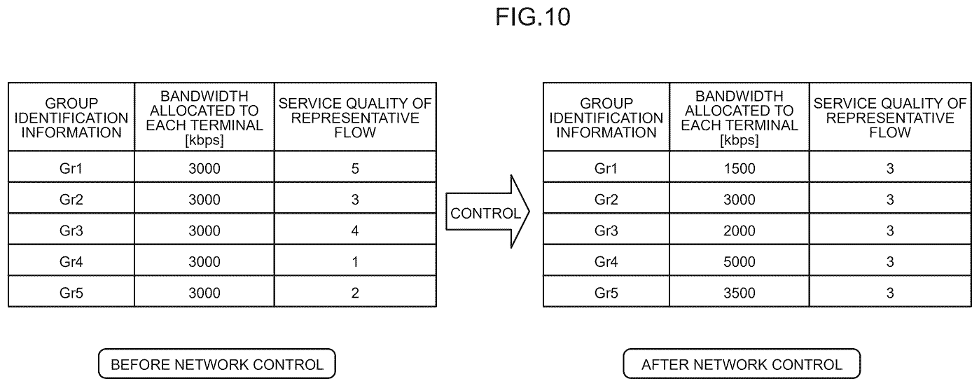

FIG. 10 is a diagram (1) for describing processing of the network control unit. Note that it is assumed that the terminals 15 belonging to a group can be specified from source addresses, destination addresses, and the like of packets belonging to flows.

In FIG. 10, the description will be made using the groups Gr1 to Gr5 (group identification information: Gr1 to Gr5). Before network control, a bandwidth allocated to each terminal belonging to the group Gr1 is set to “3000 kbps”, and service quality of a representative flow of the group Gr1 is set to “5”. A bandwidth allocated to each terminal belonging to the group Gr2 is set to “3000 kbps”, and service quality of a representative flow of the group Gr2 is set to “3”. A bandwidth allocated to each terminal belonging to the group Gr3 is set to “3000 kbps”, and service quality of a representative flow of the group Gr3 is set to “4”. A bandwidth allocated to each terminal belonging to the group Gr4 is set to “3000 kbps”, and service quality of a representative flow of the group Gr4 is set to “1”. A bandwidth allocated to each terminal belonging to the group Gr5 is set to “3000 kbps”, and service quality of a representative flow of the group Gr5 is set to “2”.

The network control unit 157 refers to the service quality of each representative flow, reduces the allocated bandwidths of the groups in which the service quality is higher than an average, and increases the allocated bandwidths of the groups in which the service quality is lower than the average, so as to uniformize the service quality. In the example illustrated in FIG. 10, the network control unit 157 reduces the allocated bandwidth of each terminal belonging to the groups Gr1 and Gr3, and increases the allocated bandwidth of each terminal belonging to the groups Gr4 and Gr5. The network control unit 157 changes the allocated bandwidths little by little, repeatedly executes the processing of changing the allocated bandwidths based on the result of the evaluation from the evaluation unit 156, and gradually uniformizes the service quality.

By the network control unit 157 executing the above processing, the service quality of the representative flows of the groups Gr1 to Gr5 is uniformized to “3”. For example, after the network control, the bandwidth allocated to each terminal belonging to the group Gr1 is set to “1500 kbps”. The bandwidth allocated to each terminal belonging to the group Gr2 is set to “3000 kbps”. The bandwidth allocated to each terminal belonging to the group Gr3 is set to “2000 kbps”. The bandwidth allocated to each terminal belonging to the group Gr4 is set to “5000 kbps”. The bandwidth allocated to each terminal belonging to the group Gr5 is set to “3500 kbps”.

Note that the network control unit 157 may control schedule priority of each terminal belonging to the same group to uniformize throughput of each terminal.

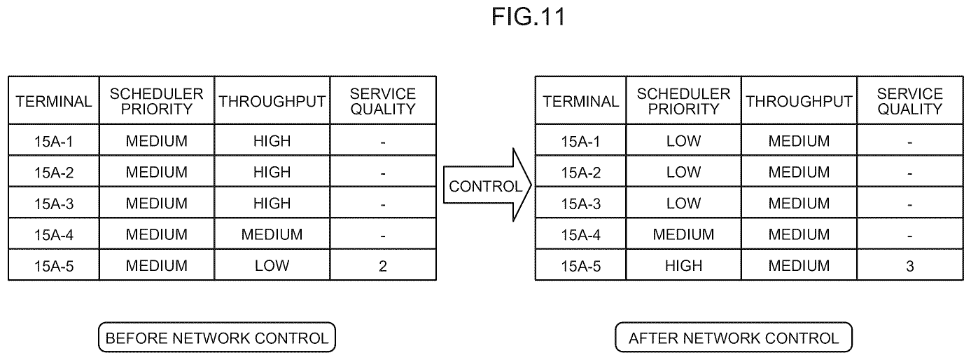

FIG. 11 is a diagram (2) for describing the processing of the network control unit. Here, the description will be made using terminals 15A-1, 15A-2, 15A-3, 15A-4, and 15A-5 belonging to a certain same group. For example, a terminal corresponding to a representative flow is set to the terminal 15A-5, and service quality of the representative flow is set to “2”. The network control unit 157 acquires information regarding scheduler priority and throughput for each terminal from a communication device on the network 5.

Before network control, scheduler priority of the terminal 15A-1 is set to “medium”, and throughput thereof is set to “high”. Scheduler priority of the terminal 15A-2 is set to “medium”, and throughput thereof is set to “high”. Scheduler priority of the terminal 15A-3 is set to “medium”, and throughput thereof is set to “high”. Scheduler priority of the terminal 15A-4 is set to “medium”, and throughput thereof is set to “medium”. Scheduler priority of the terminal 15A-5 is set to “medium”, and throughput thereof is set to “low”.

The network control unit 157 refers to the throughput of each terminal, and decreases the scheduler priority of the terminals having the throughput larger than an average and increases the scheduler priority of the terminals having the throughput smaller than the average, so as to uniformize the throughput.

By the network control unit 157 executing the above processing, the throughput of each of the terminals 15A-1 to 15A-5 is uniformized to “medium”. For example, after the network control, the scheduler priority of the terminals 15A-1 to 15A-3 is set to “low”, the priority of the terminal 15A-4 is set to “medium”, and the priority of the terminal 15A-5 is set to “high”.

The network control unit 157 executes at least one of the network control illustrated in FIG. 10 and the network control illustrated in FIG. 11.

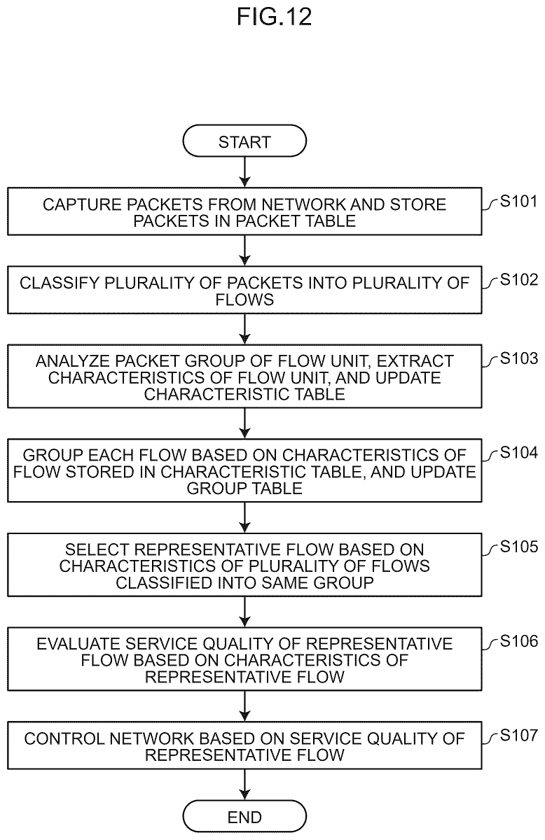

Next, an example of a processing procedure of the quality evaluation device 100 according to the present embodiment will be described. FIG. 12 is a flowchart illustrating the processing procedure of the quality evaluation device according to the present embodiment. As illustrated in FIG. 12, the network monitoring unit 151 of the quality evaluation device 100 captures packets from the network 5, and stores the packets in the packet table 141 (step S101).

The packet classification unit 152 of the quality evaluation device 100 classifies the plurality of packets stored in the packet table 141 into a plurality of flows (step S102). The characteristic extraction unit 153 of the quality evaluation device 100 analyzes a packet group of the flow unit, extracts characteristics of the flow unit, and updates the characteristic table 142 (step S103).

The grouping unit 154 of the quality evaluation device 100 groups each flow based on the characteristics of the flow stored in the characteristic table, and updates the group table 143 (step S104).

The selection unit 155 of the quality evaluation device 100 selects a representative flow based on characteristics of a plurality of flows classified into the same group (step S105). The evaluation unit 156 of the quality evaluation device 100 evaluates service quality of the representative flow based on characteristics of the representative flow (step S106).

The network control unit 157 of the quality evaluation device 100 controls the network based on the service quality of the representative flow (step S107).

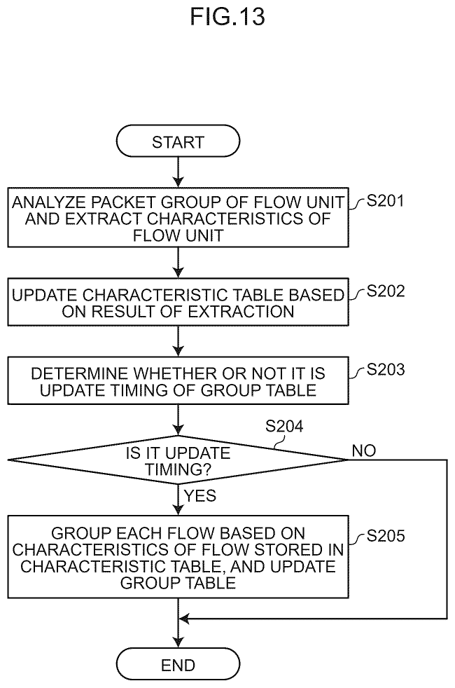

Next, an example of the processing of updating the group table 143 executed by the quality evaluation device 100 will be described more specifically. FIG. 13 is a flowchart illustrating the processing of updating the group table.

As illustrated in FIG. 13, the characteristic extraction unit 153 of the quality evaluation device 100 analyzes the packet group of the flow unit, and extracts the characteristics of the flow unit (step S201). The characteristic extraction unit 153 updates the characteristic table 142 based on a result of the extraction (step S202).

The grouping unit 154 of the quality evaluation device 100 determines whether or not it is an update timing of the group table 143 (step S203). In a case where it is not the update timing (step S204, No), the grouping unit 154 ends the update processing.

In a case where it is the update timing (step S204, Yes), the grouping unit 154 groups each flow based on the characteristic of the flow stored in the characteristic table 142, and updates the group table 143 (step S205).

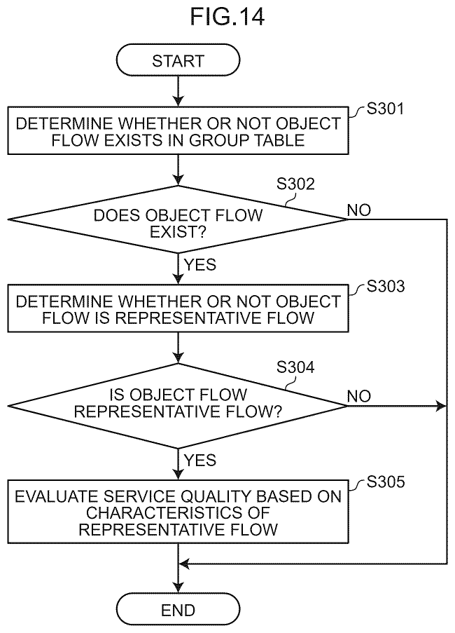

Next, an example of the processing of evaluating the service quality executed by the quality evaluation device 100 will be described more specifically. FIG. 14 is a flowchart illustrating the processing of evaluating the service quality. As illustrated in FIG. 14, the evaluation unit 156 of the quality evaluation device 100 determines whether or not an object flow exists in the group table 143 (step S301).

In a case where the object flow does not exist in the group table 143 (step S302, No), the evaluation unit 156 ends the processing of evaluating the service quality. On the other hand, in a case where the object flow exists in the group table 143 (step S302, Yes), the evaluation unit 156 proceeds to step S303.

The evaluation unit 156 determines whether or not the object flow is a representative flow (step S303). In a case where the object flow is not the representative flow (step S304, No), the evaluation unit 156 ends the processing of evaluating the service quality. On the other hand, in a case where the object flow is the representative flow (step S304, Yes), the evaluation unit 156 evaluates the service quality based on characteristics of the representative flow (step S305).

Next, effects of the quality evaluation device 100 according to the present embodiment will be described. The quality evaluation device 100 classifies a plurality of packets passing through the network 5 for each flow, extracts characteristics, and classifies flows having close characteristics into the same group. The quality evaluation device 100 selects a flow having a relatively low communication state from each group as a representative flow, and evaluates service quality for the representative flow of each group. With this configuration, it is possible to optimize the flows to be evaluated for the service quality and reduce a calculation amount related to the evaluation of the service quality.

Since the quality evaluation device 100 classifies the flows having the close characteristics into the same group and selects the representative flow from the group, it is possible to suppress an increase in the calculation amount due to an increase in the number of flows.

The quality evaluation device 100 creates a distribution of communication states of a plurality of flows included in the same group, and selects, as the representative flow, the flow having the relatively low communication state from each group based on the distribution. In this manner, the service quality of each flow in the group can also be improved by controlling the network 5 based on the service quality of the representative flow.

The quality evaluation device 100 controls, for each group, a bandwidth to be allocated to each terminal so that the quality of each representative flow becomes uniform. With this configuration, fair network operation can be implemented from a viewpoint of the service quality.

The quality evaluation device 100 controls scheduler priority of each terminal included in the same group to uniformize throughput of each terminal. With this configuration, the fair network operation can also be implemented for the service quality in the same group.

Incidentally, the content of the processing of the quality evaluation device 100 described above is an example, and the quality evaluation device 100 may execute another type of processing. For example, the quality evaluation device 100 may perform processing of detecting an abnormality based on a relationship between the result of the evaluation of the service quality and the bandwidth allocated to each terminal. The quality evaluation device 100 detects an abnormality of each terminal included in a certain group in a case where a bandwidth allocated to each terminal belonging to the certain group is equal to or more than a threshold and service quality of the certain group is less than predetermined quality. The quality evaluation device 100 may notify a management device or the like of information regarding the terminal in which the abnormality has been detected.

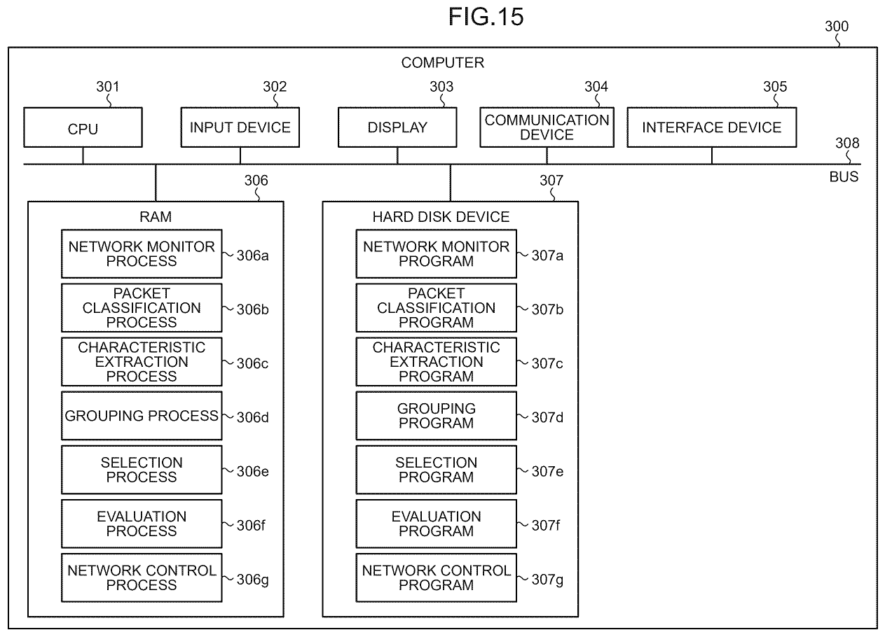

Next, an example of a hardware configuration of a computer that implements functions similar to those of the quality evaluation device 100 described above will be described. FIG. 15 is a diagram illustrating an example of the hardware configuration of the computer that implements the functions similar to those of the quality evaluation device of the embodiment.

As illustrated in FIG. 15, a computer 300 includes a CPU 301 that executes various types of arithmetic processing, an input device 302 that receives an input of data from a user, and a display 303. Furthermore, the computer 300 includes a communication device 304 that exchanges data with an external device or the like via a wired or wireless network, and an interface device 305. Furthermore, the computer 300 includes a RAM 306 that temporarily stores various types of information and a hard disk device 307. Additionally, each of the devices 301 to 307 is connected to a bus 308.

The hard disk device 307 includes a network monitor program 307a, a packet classification program 307b, a characteristic extraction program 307c, and a grouping program 307d. The hard disk device 307 includes a selection program 307e, an evaluation program 307f, and a network control program 307g. The CPU 301 reads each of the programs 307a to 307g and develops the programs 307a to 307g in the RAM 306.

The network monitor program 307a functions as a network monitor process 306a. The packet classification program 307b functions as a packet classification process 306b. The characteristic extraction program 307c functions as a characteristic extraction process 306c. The grouping program 307d functions as a grouping process 306d. The selection program 307e functions as a selection process 306e. The evaluation program 307f functions as an evaluation process 306f. The network control program 307g functions as a network control process 306g.

Processing of the network monitor process 306a corresponds to the processing of the network monitoring unit 151. Processing of the packet classification process 306b corresponds to the processing of the packet classification unit 152. Processing of the characteristic extraction process 306c corresponds to the processing of the characteristic extraction unit 153. Processing of the grouping process 306d corresponds to the processing of the grouping unit 154. Processing of the selection process 306e corresponds to the processing of the selection unit 155. Processing of the evaluation process 306 corresponds to the processing of the evaluation unit 156. Processing of the network control process 306g corresponds to the processing of the network control unit 157.

Note that each of the programs 307a to 307g does not necessarily have to be stored in the hard disk device 307 from the beginning. For example, each program is stored in a “portable physical medium” such as a flexible disk (FD), a CD-ROM, a DVD, a magneto-optical disk, or an IC card inserted into the computer 300. Additionally, the computer 300 may read and execute each of the programs 307a to 307g.

It is possible to evaluate service quality provided by an application in a communication status of a network.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a quality evaluation program that causes a computer to execute a process comprising:
acquiring a plurality of packets from a network used by a plurality of terminals for communication;
first classifying the plurality of packets into a plurality of flows based on a relationship between a source terminal and a destination terminal set in the plurality of packets;
extracting characteristics of the plurality of flows obtained at the first classifying;
second classifying the plurality of flows into a plurality of groups based on the characteristics of the plurality of flows;
selecting a representative flow based on communication states of a plurality of flows classified into the same group; and
evaluating quality of each representative flow selected from each group.

2. The non-transitory computer-readable recording medium according to claim 1, wherein the selecting includes creating a distribution of the communication states of the plurality of flows included in the same group, and selecting a flow that has a relatively poor communication state among the plurality of flows as the representative flow based on the distribution.

3. The non-transitory computer-readable recording medium according to claim 1, wherein
the second classifying includes classifying flows having similar characteristics into the same group based on the characteristics of the plurality of flows, and
the process further includes controlling, for each group, a bandwidth to be allocated to each terminal based on a result of the evaluation at the evaluating such that the quality of each representative flow is uniform.

4. The non-transitory computer-readable recording medium according to claim 3, wherein the process further includes uniformizing throughput for each terminal by controlling scheduler priority of terminals included in the same group.

5. The non-transitory computer-readable recording medium according to claim 1, wherein the process further detecting an abnormality based on a relationship between a result of the evaluation at the evaluating and a bandwidth allocated to each terminal.

6. A quality evaluation method comprising:
acquiring a plurality of packets from a network used by a plurality of terminals for communication;
first classifying the plurality of packets into a plurality of flows based on a relationship between a source terminal and a destination terminal set in the plurality of packets;
extracting characteristics of the plurality of flows obtained at the first classifying;
second classifying the plurality of flows into a plurality of groups based on the characteristics of the plurality of flows;
selecting a representative flow based on communication states of a plurality of flows classified into the same group; and
evaluating quality of each representative flow selected from each group, by a processor.

7. The quality evaluation method according to claim 6, wherein the selecting includes creating a distribution of the communication states of the plurality of flows included in the same group, and selecting a flow that has a relatively poor communication state among the plurality of flows as the representative flow based on the distribution.

8. The quality evaluation method according to claim 6, wherein
the second classifying includes classifying flows having similar characteristics into the same group based on the characteristics of the plurality of flows, and
the quality evaluation method further includes controlling, for each group, a bandwidth to be allocated to each terminal based on a result of the evaluation at the evaluating such that the quality of each representative flow is uniform.

9. The quality evaluation method according to claim 8, further including uniformizing throughput for each terminal by controlling scheduler priority of terminals included in the same group.

10. The quality evaluation method according to claim 6, further including detecting an abnormality based on a relationship between a result of the evaluation at the evaluating and a bandwidth allocated to each terminal.

11. A quality evaluation device comprising:
a processor configured to:
acquire a plurality of packets from a network used by a plurality of terminals for communication;
classify the plurality of packets into a plurality of flows based on a relationship between a source terminal and a destination terminal set in the plurality of packets;
extract characteristics of the plurality of flows obtained at the classifying;
classify the plurality of flows into a plurality of groups based on the characteristics of the plurality of flows;
select a representative flow based on communication states of a plurality of flows classified into the same group; and
evaluate quality of each representative flow selected from each group.

12. The quality evaluation device according to claim 11, wherein the processor is further configured to:
create a distribution of the communication states of the plurality of flows included in the same group is created; and
select a flow that has a relatively poor communication state among the plurality of flows as the representative flow based on the distribution.

13. The quality evaluation device according to claim 11, wherein the processor is further configured to:
classify flows having similar characteristics into the same group based on the characteristics of the plurality of flows; and
control, for each group, a bandwidth to be allocated to each terminal based on a result of the evaluation at the evaluating such that the quality of each representative flow is uniform.

14. The quality evaluation device according to claim 13, wherein the processor is further configured to uniformize throughput for each terminal by controlling scheduler priority of terminals included in the same group.

15. The quality evaluation device according to claim 11, wherein the processor is further configured to detect an abnormality based on a relationship between a result of the evaluation at the evaluating and a bandwidth allocated to each terminal.
